(19) United States
(12) Patent Application Publication
(10) Pub. No.: US 2021/0019836 A1
(43) Pub. Date: Jan. 21, 2021

(54) HOMELESSNESS INSURANCE AND A METHOD THEREFOR

(71) Applicant: Ressurrection GRAVES, Dumfries, VA (US)

(72) Inventor: Ressurrection GRAVES, Dumfries, VA (US)

(21) Appl. No.: 17/063,335

(22) Filed: Oct. 5, 2020

Related U.S. Application Data
(63) Continuation-in-part of application No. 16/363,291, filed on Mar. 25, 2019.

(51) Int. Cl. G06Q 40/08

(52) U.S. Cl. CPC G06Q 40/08

(57) ABSTRACT

The present approach provides systems and methods for insurance protection against homelessness. In some embodiments, the invention calculates a homelessness quotient for a member based upon several key factors and then uses it to provide an insurance policy whether a member is at high risk or at low risk for homelessness based upon present and pre-existing conditions experienced by the member. In some embodiments, the present approach provides a Homeless Insurance policy that may be upgraded to a Homeless Prevention Insurance policy. In some embodiments, the present approach provides a Homeless Risk Assessment.

### CROSS REFERENCE TO RELATED APPLICATIONS

This is a continuation-in-part of U.S. patent application Ser. No. 16/363,291, filed Mar. 25, 2019, and incorporated herein by reference in its entirety.

### FIELD

The present disclosure relates to systems and methods for providing insurance protection against homelessness. In particular, described herein are systems and methods relating to Homeless Insurance, Homeless Prevention Insurance, and a Homeless Risk Assessment.

### BACKGROUND

Homelessness in developed countries like America is an ever increasing, ever widening problem. It cuts across all ages, genders, ethnicities and backgrounds. It tugs at the edges of all aspects of society and threatens to encroach in places of even the greatest prosperity. It is also largely predictable. There are critical factors that most of the homeless population has in common. Some of these include pre-existing health, debt loads, job security and more. Social scientists have long been able to cull like characteristics of homeless populations in various cities and rural locales.

There does not exist a comprehensive solution to homelessness, however. What is needed is a way not only to predict homelessness down to the individual but also provide a way to prevent it, limit it or escape it altogether. At present, such a method or system does not exist.

What is needed is a solution that eliminates homelessness, mitigates against it, and/or prevents it. This solution and the particulars of its implementation are discussed at length in this application.

### BRIEF SUMMARY

This disclosure relates to systems and methods for offering and providing Homeless Insurance™, Homeless Prevention Insurance™, and a Homeless Risk Assessment™.

Under the present approach, systems and methods may provide a Homeless Risk Assessment to candidates for insurance, and to currently insured. The questionnaire and responses are transmitted and received electronically. The Homeless Risk Assessment may assess the candidate's risk of homelessness, through a variety of factors, and generate a risk score. The score may be weighted to account for various factors, such as the impact of prior experiences on the risk of homelessness. In some embodiments, a Homeless Factor may be used to account for other various, such as geographical considerations impacting housing and employment.

The Homeless Risk Assessment, in turn, generates offers to candidates for Homeless Insurance, available to currently homeless individuals, or Homeless Prevention Insurance, available to candidates. The insurance policies provide various benefits as described herein, which may range from storage fees and temporary housing, to minimally effective electronic devices and data service, to education and even employment opportunities. Advantageously, the present approach sends updating Homeless Risk Assessments at pre-determined intervals or triggering events, to re-assess an insured's risk of homelessness. Upon various changes to the risk of homelessness, a Homeless Insurance policy may be upgraded to a Homeless Prevention Insurance policy, as a reward and/or incentive to continue efforts in reducing the risk of homelessness and improving overall financial security and well-being.

Under the present approach, premiums are inverse of the risk of homelessness. Advantageously, those actively homelessness have the least obligation in terms of premium, and are able to receive support for overcoming the homeless experience. Insured at a lower risk of homelessness have a higher premium, but as described herein the policy becomes a hybrid policy to earn cash value and provide further benefits.

The systems and methods described herein allow for electronic and near-real time tracking of an insured's status, policies and claims, progress towards various financial and housing goals, educational opportunities, need for support services, availability of support services, and the like. For example, in some embodiments an insured may be connected with potential employment opportunities through an application operated by an electronic device. As another example, a case manager may communicate with, track the status of, and provide various support services to an insured in response to a claim.

Accordingly, some embodiments of the present approach provide a method of preventing homelessness. It comprises:
Identifying an eligible insurable pool;
Analyzing the eligible insurable pool to determine each member's eligibility within the pool;
Calculating a homelessness quotient for the eligible insurable pool;
Applying the homelessness quotient to each member within the eligible insurable pool;
Assigning a homelessness quotient to each said eligible member within the eligible insurable pool;
Creating an insurance risk pool for each member achieving homelessness quotient; and
Providing insurance that mitigates against homelessness for each member in the insurance risk pool.

One of the key criteria used to calculate the homelessness quotient is a member's entire credit profile which includes a member's credit rating amongst multiple other credit related criteria. Eligible credit ratings for consideration therein range from about 350 to about 650. They may also range from about 400 to about 600. Another such criteria is the average salary of a member. Eligible average salaries for consideration are less than about one-hundred thousand dollars, less than about seventy-five thousand dollars, less than about fifty thousand dollars or less than about twenty-five thousand dollars. Importantly, the actual salary of each subject member is also used as part of the calculation in the homelessness quotient.

Another key criteria used to calculate the homelessness quotient a member's net worth. Eligible net worth for consideration is less than about one-hundred thousand dollars, or less than about seventy-five thousand dollars, or less than about fifty thousand dollars or less than about twenty-five thousand dollars. An additional criteria used to calculate the homelessness quotient is a member's average debt load. Eligible debt load for consideration is one of at least seventy percent, at least fifty percent, or at least thirty-five percent. In an alternate version of the homelessness quotient calculation herein, the HQ may be calculated in which a member has an unlimited cap on salary.

A member's student loan debt is another criteria for use in the analysis of a member's homelessness quotient. Eligible student loan for consideration is at least one-hundred thousand dollars, at least seventy-five thousand dollars, or at least fifty thousand dollars.

In all, the homelessness quotient may be calculated from a combination of a member's age, address, credit rating, state of employment, employment history, salary, net worth, debt load, student loan debt, level of education, military service, presence of pre-existing health or mental condition, kind of pre-existing health or mental condition, and religious affiliation, pre-existing exposure to poverty and/or homelessness. Additional criteria may be added as is necessary to effectively define the homelessness quotient.

In some embodiments, the present approach may take the form of a computer-implement system for providing and managing homeless insurance policies. The system may include an insurance server having an insurance database, an electronic homeless risk assessment questionnaire, a candidate risk assessment database, an insured risk assessment database, a homeless risk score database, a processor, and a non-transitory memory. The system may also include a plurality of user electronic devices in communication with an insurance server. The user devices may include candidate electronic devices, for individuals seeking homeless insurance, and insured electronic devices, for individuals having homeless insurance or homeless prevention insurance. The system may include policy and claims manager electronic devices in communication with an insurance server, who have various involvement in managing policies, policy upgrades, homeless risk assessments, claims, and the like.

Under the present approach, the non-transitory memory stores instructions that, when executed by the processor, cause the insurance server to perform various tasks. For example, the system may:
receive homeless insurance requests from candidate electronic devices, and distribute electronic risk assessments to the candidate electronic devices in response to the homeless insurance requests;
receive electronic risk assessments from candidate electronic devices, calculate a homeless risk score for each candidate based on electronic risk assessment responses, and update the homeless risk score database with the calculated homeless risk scores;
from the received electronic risk assessments from candidate electronic devices, identify a first portion of candidates currently homeless, and transmit a homeless insurance policy offer to the first portion of candidate electronic devices;
from the received electronic risk assessments from candidate electronic devices, identify a second portion of candidates having a risk of homelessness, and transmit a homeless protection insurance policy offer to the second portion of candidate electronic devices, wherein the homeless protection insurance policy offer includes a premium amount for each candidate inversely related to the candidate's risk of homelessness;
identify a portion of insured electronic devices due for receipt of an electronic homeless risk assessment, and deliver electronic homeless risk assessments to the identified portion of insured electronic devices;
receive electronic risk assessments from insured electronic devices, calculate an updated homeless risk score for each insured based on electronic risk assessment responses, and update the homeless risk score database with the updated homeless risk scores;
from the updated homeless risk scores, identify a first portion of insured qualified for a change in premium, update the insurance database with the change in premium, and transmit to the first portion of insured electronic devices the change in premium;
from the updated homeless risk scores, identify a second portion of insured qualified for a change in cash value accrual, update the insurance database with the change in cash value accrual, and transmit to the second portion of insured electronic devices the change in cash value accrual; and
receive claims and claim information from insured electronic devices, updating the insurance database with the claim and claim information, transmit a claim summary to the policy and claims manager electronic device, identify service benefits associated with each claim, and transmit the identified service benefits associated with a particular claim to the claiming insured electronic device.

In some embodiments, the system may have a plurality of service benefit electronic devices, and the insurance server may transmit the claim summary and an identified service benefit associated with a claim to a service benefit electronic device, thereby providing the identified service benefit to the insured. The insurance server may also:
receive service reports from the plurality of service benefit electronic devices, a service report containing a claim identifier, insured identifier, identified service benefit, and a confirmation of services provided;
update the insurance database with the service report and an expected electronic homeless risk assessment questionnaire change;
send a claim update summary to the policy and claims manager electronic device with an option for the policy and claims manager electronic device to instruct the insurance server to transmit an updating electronic homeless risk assessment to a specified insured electronic device;
if instructed, transmit an updating electronic homeless risk assessment to a specified insured electronic device;
receive an updated electronic homeless risk assessment to a specified insured electronic device;
compare the updated electronic homeless risk assessment to the expected electronic homeless risk assessment questionnaire change; and send a second claim update summary to the policy and claims manager electronic database comparing the updated electronic homeless risk assessment to the expected electronic homeless risk assessment questionnaire change.

Some embodiments may include a cash value database, for tracking the cash value for policies accruing cash value. For example, the insurance server may maintain and update the cash value of a homeless protection insurance policy upon receipt of a premium payment, and in view of a cash value accrual.

In some embodiments, the insurance server may include beneficiary designations data, and the insurance server to transmit a request for beneficiary designations data to an insured electronic device, and receive beneficiary designations data from an insured electronic device.

Some embodiments may include a plurality of prospective employer electronic devices. The insurance server may receive prospective employment data from a prospective employer electronic device, and transmit prospective employment opportunity data to a portion of the insured electronic devices. In this manner, certain local employers looking for specific skills associated with an insured may connect with an insured having the desired skills and availability for employment.

Some embodiments may include an insured status database having housing and employment information for a portion of insured. The insurance server may transmit to the portion of insured a status update request, receive a status update from an insured electronic device updating at least one of housing status and employment status, and then update the insured status database with updated housing and employment information. Further, the insurance server may, upon receipt of a status update from an insured electronic device, send an update summary to the policy and claims manager electronic device with an option for the policy and claims manager electronic device to instruct the insurance server to transmit an updating electronic homeless risk assessment to a specified insured electronic device.

Some embodiments may include a payment database with data indicating wages earned by a specified insured. The payment database may be configured to receive wages paid to a specified insured by a specified employer, and the non-transitory memory stores instructions that, when executed by the processor, cause the insurance server to transmit a wage notification to the specific insured electronic device. In such embodiments, the system may be used to assist the insured with financial responsibility, such as by allocating wages earned for premium payment, housing and living expenses, and the like.

In some embodiments, the insurance server may receive an updated electronic risk assessment from an insured electronic device, calculate an updated homeless risk score for the specific insured associated with the insured electronic device, and based on the updated homeless risk score, transmit an offer to the specific insured electronic device to upgrade a homeless insurance policy to a homeless prevention insurance policy, the offer containing an estimated premium based on the updated homeless risk score. The insurance server may receive an acceptance from the specific insured electronic device, and update the insurance database with the specific insured's acceptance, a new homeless prevention insurance policy identifier, and a premium associated with the new homeless prevention insurance policy identifier. In this manner, a homeless insurance policy may be upgraded to a homeless prevention insurance policy, and both reward and encourage the insured to continue improving housing and financial security.

These and further embodiments will be appreciated by those having ordinary skill in the art, in view of the description and drawings, and claims appended hereto.

### DESCRIPTION OF THE DRAWINGS

FIG. 1 is a flow chart showing a method for determining a Homelessness Quotient according to an embodiment of the present approach.

FIG. 2 is a block diagram of a Homeless Risk Assessment Questionnaire according to the present approach.

FIG. 3 illustrates an embodiment of an electronic, computer-implemented system of the present approach.

FIG. 4 illustrates the inverse premium-risk approach, including a transition to a hybrid, cash-value policy.

### DESCRIPTION

The following description is of the best currently contemplated mode of carrying out exemplary embodiments of the present approach. The description is not to be taken in a limiting sense, and is made merely for the purpose of illustrating the general principles of the inventive aspects of the present approach.

Disclosed herein are systems and methods for providing a Homeless Risk Assessment to candidates for insurance, and to currently insured, offering and providing homeless-related insurance products, tracking insured individuals' behavior and progress towards overcoming homelessness, reducing the risk of homelessness, and achieving housing and financial security. The questionnaire and responses are transmitted and received electronically, through electronic devices such as a personal smart phone, tablet computer, laptop computer, and the like. The Homeless Risk Assessment may assess the candidate's risk of homelessness, through a variety of factors, and generate a risk score. The score may be weighted to account for various factors, such as the impact of prior experiences on the risk of homelessness. In some embodiments, a Homeless Factor may be used to account for other various, such as geographical considerations impacting housing and employment.

The Homeless Risk Assessment, in turn, generates offers to candidates for Homeless Insurance, available to currently homeless individuals, or Homeless Prevention Insurance, available to candidates. The insurance policies provide various benefits as described herein, which may range from storage fees and temporary housing, to minimally effective electronic devices and data service, to education and even employment opportunities. Advantageously, the present approach sends updating Homeless Risk Assessments at pre-determined intervals or triggering events, to re-assess an insured's risk of homelessness. Upon various changes to the risk of homelessness, a Homeless Insurance policy may be upgraded to a Homeless Prevention Insurance policy, as a reward and/or incentive to continue efforts in reducing the risk of homelessness and improving overall financial security and well-being.

As used herein, the term “candidate” means an individual legally capable of being insured, and under consideration for a form of insurance described herein. The term “insured” means in individual having an insurance policy described herein.

As used herein, the term “homeless” has the same meaning as the definition of homelessness contained in the Homeless Emergency Assistance and Rapid Transition to Housing Act. The definition affects who is eligible for various HUD-funded homeless assistance programs. The definition includes four broad categories of homelessness:
1. A person who is living in a place not meant for human habitation (e.g., tent, woods, abandoned building, bus stop, etc.), in emergency shelter, in transitional housing, or are exiting an institution where they temporarily resided for up to 90 days but were in shelter or a place not meant for human habitation immediately prior to entering that institution.
2. A person who is losing a primary nighttime residence, which may include a motel or hotel or a doubled-up scenario, within 14 days and lack resources or support networks to remain in housing.
3. Families with children or unaccompanied youth who are unstably housed and likely to continue in that state.
4. A person fleeing or attempting to flee domestic violence, having no other residence, and lacking the resources or support networks to obtain other permanent housing.

This can include adults or children: sharing the housing of others due to, e.g., loss of housing or economic hardship; living in motels, hotels, trailer parks, or camping grounds due to the lack of alternative adequate accommodations; living in emergency or transitional shelters; or maintaining a primary nighttime residence in a public or private place not designed for or ordinarily used as a regular sleeping accommodation for human beings.

By the term “debt load” or “eligible debt load,” it is meant herein the total percentage of a member's debt as compared to the member's total monthly received income.

By the term “student debt load,” it is meant herein the percentage that a member's student loan debt is in comparison to the member's total monthly received income.

By the term “pre-existing health or mental condition.” it is meant herein a verifiable physical or mental health condition that a member has before consideration for coverage by the described homelessness insurance herein.

By the term “homelessness insurance.” it is meant a monetary guarantee of compensation for specified losses, damage, illnesses (i.e., catastrophic losses) that can lead to a member or member's family becoming homeless as a direct result of a one or more catastrophic losses.

By the term “Homelessness Quotient” or “HQ.” it is meant herein the factor by which a person or a demographic of persons are assessed for the probability of homelessness over a given time period. e.g., five years, 10 years, lifetime.

In some embodiments, the present approach takes the form of a Homeless Risk Assessment, a computer-implemented tool used to determine the risk of the candidate to experience homelessness. In some embodiments, if a candidate responding to the Homeless Risk Assessment indicates a current status of homelessness, then the candidate receives the minimum assessment score and is offered Homeless Insurance as discussed above, instead of Homeless Prevention Insurance.

In a demonstrative embodiment, the Homeless Risk Assessment is a computer-generated questionnaire for candidates to complete through an offeror's website. In some embodiments, after the candidate completes the questionnaire, the candidate receives an offer for a fully-executed policy, in exchange for a fully automated premium payment using an ACH debit. In some instances, there may be a delay as the system confirms identity or other bona fide parameters. However, use of a computer-generated Homeless Risk Assessment eliminates the need for local insurance agents to sell the policies. Additionally, the computer-generated Homeless Risk Assessment eliminates the potential for human error, subjective screening, and unfair discrimination. Premium differences between insured become dependent on the possibility of an insured becoming homeless.

In embodiments of the present approach, the underwriter or other entity may provide a calling station to handle inbound calls regarding policy questions and claims. These are known in the art, and as such are not described herein.

The Homeless Risk Assessment questionnaire has an algorithm that creates a computer-generated score, as discussed above. For example, in some embodiments, the computer-generated score is proportional to the risk of the insured becoming homeless. The less the insured's score, the less risk that the insured has of becoming homeless.

In some embodiments, an insured receives login credentials and membership to a secured website for maintaining the insured's account, and taking advantage of other opportunities through the insurance provider, such as financial seminars and other related topics.

In some embodiments, underwriters and fraud investigators will be assigned to review each insured's file and confirm that the self-reported information is correct. Advantageously, the present approach incorporates the option for a candidate to upload sample documents and link the account to other accounts, such as banking account statements and employment documents, to provide a read-only option for confirming representations made by the candidate in connection with responding to the Homeless Risk Assessment. The computer-implemented solution may allow the candidate to upload documents, link accounts, or provide contact information to employers, for an underwriter or investigator to contact and confirm aspects of the candidate's representations.

In some embodiments, candidates are offered a financial literacy and entrepreneurship program designed to teach fundamental skills for understanding the basic financial issues for maintaining a home, and for pursuing and securing steady income. In some embodiments, the financial literacy and entrepreneurship program is a mandatory participation program for candidates selected for Homeless Prevention Insurance.

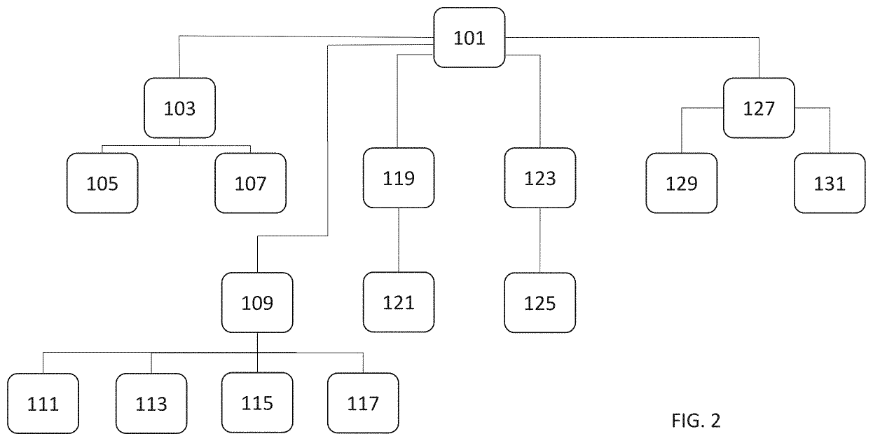

FIG. 2 is a block diagram of a Homeless Risk Assessment Questionnaire according to an embodiment of the present approach. Homeless Risk Assessment Questionnaire 101 draws from a candidate's Financial Literacy 103, Financial History 109, Demographics 119, Traumatic Event History 123, and Homeless History 127.

Financial Literacy 103 involves exploring the candidate's understanding and experience with managing personal and family finances. For example, can the candidate write a check? Has the candidate ever taken a course on budgeting? Does the candidate understand interest rates and know what are the interest rates on existing loans and credit accounts?

A first sub-category of Financial Literacy 103 is Job and Income Stability 105. This category considers how the candidate earns income, how long the candidate has earned income, and the like. A second sub-category of Financial Literacy 103 is Income and Debt 107, which identifies all sources of the candidate's income and debt, including total balances, interest rates, payment and receipt schedules, and similar information, as well as the candidate's understanding of business and investment income and debt.

Financial History 109 includes assessments of the candidate's Credit Report 111, the candidate's monthly Debt-to-Income 113, the candidate's Net Assets from Liabilities 115, and the candidate's Tax History 117. For example, Tax History 117 may inquire about the candidate's tax history over the past 5, 6, 10, 15, 20, etc. years, including whether the candidate owes any federal, state, or local taxes, and whether the candidate is on a tax payment plan. In some embodiments, the candidate may be requested to authorize a release of tax history information, and/or provide a copy of recent tax return filings.

Demographics 119 explores the candidate's race and ethnicity, as well as the candidate's educational background and nationality. This category can also include an assessment of the demographics in the candidate's geographical area. For example, the inquiry may request the candidate to identify the candidate's race, nationality, ethnic origin, citizenship status, place of birth, gender at birth. The inquiry may also request information relating to the candidate's geographical area. In some embodiments, the inquiry may draw demographic data for the candidate's geographical area from public information sources, such as local government databases.

The candidate's Personal Profile 121 may be included as a sub-category of Demographics 119. Personal Profile 121 addresses the candidate's identification, from age, race, and ethnicity, to other unique identity identifiers (such as, e.g., Driver's License number. Social Security number, etc.), family and personal history elements. For example, the inquiry may request the candidate to identify, for example, a full legal name and any aliases; Date of Birth; Social Security Number and/or Driver's License number and/or Passport Number; Approximate number of times the candidate has been out of the country in the past 5, 10, or 20 years; current legal and mailing addresses; current employer and employment situation; telephone number; email address; personal social media, etc. An embodiment may also request the same information for the candidate's spouse or partner, parent(s), siblings, and/or emergency contacts. The candidate may also be asked to identify each dependent of the candidate.

In some embodiments, the Personal Profile 121 may also inquire about the candidate's financial situation in the form of various questions. For example:
How many jobs have you had in the last ten years?
What is your current job title?
Do you know how to create and update your resume professionally?
What is your current salary or income?
Do you have knowledge of how to write a check? How comfortable?
Do you have knowledge of how to pull your credit report? How comfortable?
Do you have expert knowledge of how to write a budget? How comfortable?
What is your credit score today? (multiple choice, providing common ranges for excellent, good, fair, and poor)
What has your credit score been on average for the last five years? (multiple choice, providing common ranges for excellent, good, fair, and poor)
If you lost your job or income today, what would you do? (Check all that apply, providing a list of common options)
Do you earn income hourly, via salary, and/or commission? (multiple choice, allowed to check more than one)
How many hours per week do you work? (multiple choice question or numerical selection)
What assets do you have under your name? (Check all that apply)
Do you own a business?
What is the most in gross sales revenue that you have made in your business in the last three years?
   Of course, these are demonstrative questions, and embodiments may use different questions without departing from the present approach.

Traumatic Events 123 is an assessment of the candidate's history to identify potential sources of trauma, which can, in turn, factor into the assessment of the candidate's homeless risk. For example. Traumatic Events 123 may explore past history of trauma, such as child abuse, sexual abuse, and domestic violence, as traumatic experiences may have correlation with a candidate's risk of homelessness. Military Record 125 is also relevant, and the Questionnaire may in some embodiments include an assessment of violence in the candidate's neighborhood.

For example, in some embodiments, the candidate may be asked to respond to the following questions:
Have you ever experienced Child Sexual Abuse, Rape or otherwise sexual misconduct?
Have you ever experienced Homelessness?
   As a child or an adult?
   (If yes) How long did you experience homelessness?
   (If yes) How many different times did you experience homelessness?
Have you ever gone to see a religious or spiritual leader, clinical professional for mental or emotional health needs?
Have you ever been diagnosed with a mental health disease? (check all that apply)
Did you serve in the military?
   (If yes) What branch? (check all that apply)
   (if yes) Did you retire?
   (If yes or no) Under what conditions were you discharged? (Multiple Choice)
Have you ever done any drugs?

Homeless History 127 makes an assessment of the candidate's housing situation over a prior time period, such as ten years, twenty years, since the candidate became a legal adult or emancipated minor, or, in some embodiments, the candidate's lifespan. The candidate's Mental and Physical Health 129 may be assessed, as well as the candidate's Criminal History 131.

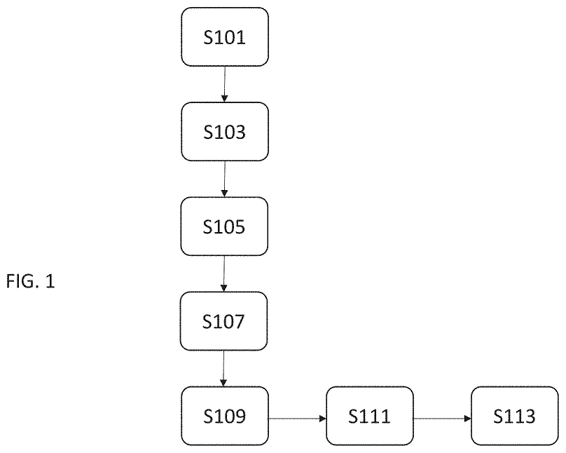

Embodiments may provide common selections for various questions, enabling an easier response for the candidate, as well as a pre-defined scoring metric for each question. The following paragraphs describe embodiments for providing a method of preventing homelessness incorporating a Homelessness Quotient, which may be a result of a Homeless Risk Assessment. It should be appreciated that the following illustrates one embodiment, and that other embodiments are contemplated without departing from the present approach. Generally, such embodiments comprise the following, as illustrated in connection with FIG. 1:
Identifying an eligible insurable pool of candidates S101;
Analyzing the eligible insurable pool to determine each candidate's eligibility within the pool S103;
Calculating a Homelessness Quotient for the entire eligible insurable pool S105;
Applying the Homelessness Quotient to each candidate within the eligible insurable pool S107;
Assigning a Homelessness Quotient to each candidate within the eligible insurable pool S109;
Creating an insurance risk pool for each candidate achieving a Homelessness Quotient above a threshold S111; and
Providing insurance that mitigates against homelessness for each candidate in the insurance risk pool S113.

One of the criteria used to calculate the Homelessness Quotient is a member's credit rating. The acceptable credit rating, or range of acceptable credit ratings, may depend on the particular embodiment, as well as other factors. For example, in some embodiments, eligible credit ratings for consideration therein range from about 300 to about 900. They may also range from about 400 to about 600. Another criteria used is the average salary of a member over a number of previous years (e.g., 3, 5, 7, or 10 years, etc.). Eligible average salaries for consideration may depend on the embodiment, and are generally less than about one-hundred thousand dollars, less than about seventy-five thousand dollars, less than about fifty thousand dollars or less than about twenty-five thousand dollars or a limitless salary cap. In some embodiments, the eligible average salary range also depends on the local cost of living. In some embodiments, the homelessness quotient may apply a sliding scale for individual variables, such that the acceptable range of one criteria (e.g., credit rating) may depend on the value of another criteria (e.g., average salary over a number of previous years).

Another criteria used to calculate the homelessness quotient a member's net worth. Eligible net worth for consideration is less than one-hundred thousand dollars less than seventy-five thousand dollars, less than fifty thousand dollars or less than twenty-five thousand dollars. An additional criteria used to calculate the homelessness quotient is a member's average debt load. Eligible debt load for consideration is one of at least seventy percent, at least fifty percent, or at least thirty-five percent.

A member's student loan debt is another criteria for use in the analysis of a member's homelessness quotient. Eligible student loan for consideration is at least one-hundred thousand dollars, at least seventy-five thousand dollars, or at least fifty thousand dollars.

In all, the homelessness quotient may be calculated from a combination of a member's age, address, credit rating, state of employment, employment history, salary, net worth, debt load, student loan debt, level of education, military service history, active military service, presence of pre-existing health or mental condition, kind of pre-existing health or mental condition, group demographic information, work history, financial education, multi-generational socio-economic data (e.g., history of poverty, wealth), number of income streams, current number of jobs, history of homelessness, history of abuse and religious affiliation, if any.

Each of the above factors may be included in the calculation of the homelessness quotient (HQ). Also, in some embodiments, no more than five of the above factors may be included and/or no more than ten of the above factors may be included. The practitioner has flexibility and may use the five or more factors noted hereinabove to calculate the HQ depending upon the location, size, type and membership of a would-be insurance pool. Persons of skill in the art will readily recognize the designability of the HQ and customize same as is necessary and desired.

The HQ may be used in the overall method to issue insurance to mitigate against homelessness, prevent it or cure it. In practice, each of the factors is given a weighted score. The sum of the scores is taken to provide a Homelessness Number (HN). The HN is then weighted by a separate Homelessness Factor (HF) to produce a Raw Homelessness Quotient (RHQ). Once weighted, an algorithm is applied to the HN to form the final HQ, i.e., the Homelessness Quotient. The following EXAMPLES are exemplary.

### Example I

### Questionnaire—Homeless Risk Assessment (HRA)

This is an example questionnaire for a prospective client for homelessness:

1. Address?

2. Current credit debt?

3. Student loan debt?

4. Personal history of homelessness?

5. Family history of homelessness?

6. Past military service?

7. College education level?

8. Currently employed?

9. Personal history of abuse?

10. Pre-existing illness?

11. Current illness?

12. Mental health history?

13. Parents' economic status (low/middle/high)?

14. Level of education?

15. Current salary?

16. Credit rating?

In embodiments of the present approach, the inquiries set forth in Example I are made via electronic device, and may be in the form of an interactive website, a mobile device application, or other computer-implemented devices allowing for a candidate to receive the inquiry, and provide a response. The candidate's responses may then be stored in an electronic database, and each response given a weighted score. Example II, below, illustrates a candidate's responses and weights assigned to each response.

### Example II

| | | WEIGHTED SCORE |
|---|---|---|
| QUESTION | ANSWER | (1-5) or (0/1) |
| Address? | 123 Main Street, | 3 |
| | Milwaukee, Wisconsin | |
| Current credit debt? | $25,000 | 4 |
| Student loan debt? | $80,000 | 3 |
| Personal history of | N | 0 |
| homelessness? | | |
| Family history of | Y | 1 |
| homelessness? | | |
| Past military service? | N | 0 |
| College education level? | 4 | 0 |
| Currently employed? | Y | 0 |
| Personal history of abuse? | Y | 1 |
| Pre-existing illness? | Y | 1 |
| Current illness? | N | 0 |
| Parents' economic status | M | 3 |
| (low/middle/high)? | | |
| Level of education? | College | 1 |
| Current salary? | $85,000 | 2 |
| Average credit rating? | 690 | 3 |
| | Homelessness Number | 22 |
| | (HN): | |

Homelessness Number (HN) * Homelessness Factor (HF) = Raw Homelessness Quotient (RHQ) e.g., 22 * 0.35 = 7.7

Homelessness Number (HN)*Homelessness Factor (HF)=Raw Homelessness Quotient

(RHQ) e.g., 22*0.35=7.7

As noted hereinabove, an algorithm is then applied to the Raw Homelessness Quotient (RHQ) to produce the final Homelessness Quotient for Example II. The Homelessness Factor may be a pre-determined adjustment for a geographical location, to account for the relative availability of employment and housing, among other factors.

In Example II, the Weighted Score is determined for each individual category. Embodiments may use a maximum score for each category, and certain categories may have a higher maximum score. For example, certain categories may have a maximum score of 10 points, and certain categories may have a maximum score of 5 points, in the same embodiment. Each category includes a set of questions. In some embodiments, each question has a specific number associated with it. Based on the candidate's answer to the question, the system would either increase the score by 5 or 10 points or decrease the score by 5 or 10 points. As an example: Have you ever been homeless? This questions is worth 10 points because the purpose of the insurance is to evaluate the risk of homelessness. All homeless history questions, for example, may be worth 10 points. This means that any candidate, regardless of race, religion, nationality, sex, or other identifier, will answer this question and receive an objective score update. If a candidate has been homeless before, the score increases by 10 points. This objective measurement accounts for the increase in future homelessness risk based on prior homelessness experiences.

In some embodiments, the score for a specific question may be weighted, such as the HF referenced above. The weight may be based on the frequency, length of time, intensity, and/or severity of a response. Using the previous question as an example, a positive response to “Have you ever been homeless?” may lead to follow-up questions asking for home many times, the duration of each homelessness instance, and the approximate date(s) for each instance. If a candidate has never been homeless, the score may be 0. If a candidate has had one homelessness experience, lasting 1-7 days, the score may be 3. If a candidate has had one homelessness experience, lasting 1-7 days, but the experience happened more than one decade ago, the score may be 2. If a candidate has had one homelessness experience, lasting 1-7 days, within the past year, the score may be 8. If a candidate has had one homelessness experience, lasting 1-7 days, within the past year, the score may be 7. If a candidate has had multiple homelessness experience, lasting 1-4 weeks, within the past decade, the score may be 9. Factors that tend to increase the risk may increase the relative weight, and factors that tend to decrease the risk may decrease the relative weight. The table below shows examples of a relative weighting scheme for certain categories and for sub-questions within a category. It should be appreciated that the particular weighting scheme used may depend based on the particular embodiment.

| | IMPACT | RELATIVE |
|---|---|---|
| FACTOR | ON RISK | WEIGHT |
| Currently homeless | Triggers | X |
| | immediate offer | |
| Monthly income >3 times | decrease | −3 |
| Monthly debt | | |
| Monthly income <3 times but >2 | neutral | 0 |
| times Monthly debt | | |
| Monthly income <2 times Monthly | increase | +1 |
| debt | | |
| Monthly income < Monthly debt | increase | +4 |
| Family history of homelessness? | increase | +1 |
| Homeless in prior 10 years | increase | +3 |
| Homeless in past 12 months | increase | +5 |
| Multiple homelessness experiences | increase | +5 |
| Homeless experience >1 week, <1 | increase | +3 |
| month | | |
| Homeless experience >1 month | increase | +5 |
| Past military service involving | increase | +3 |
| combat | | |
| Currently unemployed | increase | +3 |
| Prior employment experiences <1 | increase | +1 |
| year each | | |
| Prior employment experiences >1 | decrease | −1 |
| year each | | |
| Average FICO credit score <599 | increase | +3 |
| Average FICO credit score >600, | increase | +1 |
| <749 | | |
| Average FICO credit score >750, | decrease | −1 |
| <800 | | |
| Average FICO credit score >801 | decrease | −3 |

In some embodiments, the total potential score (e.g., representing the highest risk) may be assigned a certain value. For example, in an embodiment having a total risk score of 100, the candidate who has received the most points out of 100, will be identified as being most at risk for homelessness. Candidates in certain ranges may be identified as having similar risk levels. The candidates in similar risk levels may assigned a premium amount indicative of the risk level. The premium and the risk level may depend on the geographical location. For example, high-risk candidates (e.g., representing the highest 20% of scores, or highest 15% of scores, or highest 10% of scores, or highest 5% of scores, or highest 1% of scores, etc.), living within a region identified with higher incidents of homelessness, may be adjusted relative to candidates living within a region identified with lower incidents of homelessness.

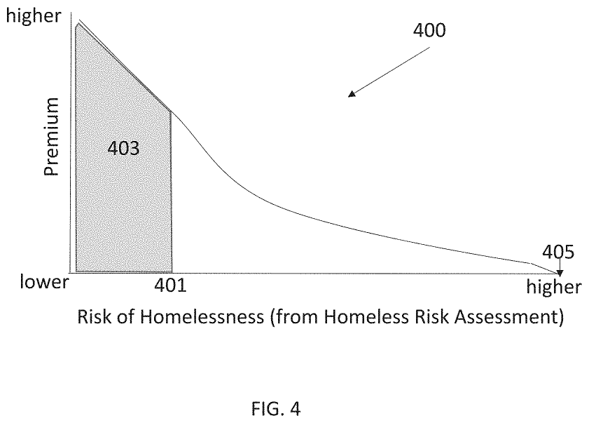

In one novel aspect of the present approach, candidates in the highest risk ranges (e.g., depending on the embodiment, representing the highest 20% of scores, or highest 15% of scores, or highest 10% of scores, or highest 5% of scores, or highest 1% of scores, etc.) pay less of a premium than candidates in the lowest risk ranges (e.g., representing the lowest 20% of scores, or lowest 15% of scores, or lowest 10% of scores, or lowest 5% of scores, or lowest 1% of scores, etc.). Candidates with lower scores, and therefore less risk of homelessness, will pay more of a premium relative to the candidates at a higher risk of homelessness. The candidate in the lowest risk ranges may pay higher premiums, but may be eligible to adjust the policy to a cash value policy as described herein. In this manner, the present approach rewards insured through continued participation and, after successfully reducing the risk of homelessness, can begin to build wealth through their policy. Insured are reevaluated on a repeating basis. e.g., every year, 2 years, 3 years, etc., through the Homeless Risk Assessment as described herein, and may be moved from risk group to risk group, depending on changes to the individual's risk. FIG. 4 illustrates this concept. Plot 400 shows the premium amount as a function of the candidate's risk of homelessness. As can be seen, at a certain risk 401, the policy involves a higher premium, but that a portion of that premium may contribute to a cash value of the policy, represented by area 403. Those currently experiencing homelessness, at risk 100, represented at 405, may have the lowest premium. As can be seen, the lower the Homeless Risk Assessment score, the higher the premium. It shows that the insured has demonstrated financial security with disposable income to invest in creating cash value in a policy. In some embodiments, these premiums fluctuate when the policies are renewed. For hybrid policies having a guaranteed amount, the guarantee may be set at a specific value, such as any amount from, and including, $100,000 to, and including, $10,000.000.

The algorithm as described above computes the total score for each candidate, and then generates an outcome decision. There are multiple outcomes of the Homeless Risk Assessment:
1. If the candidate is homeless, the candidate automatically receives an offer for homeless insurance. This policy is a term life policy, and provides the benefits described below in exchange for timely premium payment. Advantageously, systems and methods of the present approach may be performed using electronic devices, simplifying the receipt of premium payments and provision of services under the policy.
2. If the candidate is identified as being in a high risk range, the candidate is offered a policy involving a lower premium (relative to the premium for low risk ranges), for a hybrid policy that is similar to whole life insurance. Under the present approach, the hybrid policy allows the insured's policy to earn cash value, which may be used and passed-down to avoid homelessness. In some embodiments, the cash value may not be withdrawn without a hefty penalty.
3. If the candidate is identified as being in a low risk range, the candidate is offered a policy involving a higher premium (relative to the premium for high risk ranges), for a hybrid policy similar to whole life insurance. These candidates receive a definite policy of a guaranteed amount (which can depend on the embodiment), and may build cash value in the policy. In addition, the hybrid policy includes an estate planning option so that an insured may bequeath the policy itself. e.g., as inheritance to their heirs. The insured may, if desired, determine that the beneficiaries must maintain the policy, pay premiums from the cash value, or impose other restrictions on the policy regarding the future distribution of cash value. Just as a person can put in their will that a property must remain owned by the family for the benefit of the family/beneficiaries, this insurance policy allows the insured to require the policy to continue instead of being cashed out and can do so up to 5 generations.

In embodiments of the present approach, the inquiries set forth in Example I are made via electronic device, and may be in the form of an interactive website, a mobile device application, or other computer-implemented devices allowing for a candidate to receive the inquiry, and provide a response. The candidate's responses may then be stored in an electronic database, and each response given a weighted score. Example II, above, illustrates a candidate's responses and weights assigned to each response.

In some embodiments, the present approach provides Homeless Insurance, a product specifically intended for homeless people. In some embodiments, there only criterion for eligible pool determination is whether the candidate is confirmed to be a homeless person, as described above. The purpose of Homeless Insurance is to assist an insured with permanently eliminating homelessness. In embodiments of the present approach, the Homeless Insurance policy provides furniture and belonging storage fees and an allowance for temporary living situations (e.g., hotel room, short-term housing, etc.), for a specific amount of time. The time or insurance “term” may be, e.g., 1 week, 2 weeks, 3 weeks, 4 weeks, 1 month, 2 months, 3 months, etc., depending on the particular policy and insured's premium. During this time, the policy also provides the insured with education and training to overcome the current homelessness through acquiring a housing solution (e.g., through securing a lease for at least 6 months or 1 year, closing a purchase of a home).

In some embodiments, the present approach provides an in-house program that teaches financial literacy and other useful education. In addition to life and money skills, these programs monitors the active cases of insured who are experiencing homelessness. Case managers work closely with claims managers of the insured to ensure that disbursement of the claim happens timely, and covers the immediate needs of the insured. This may include, for example, checks to storage locations to cover fees, payments to hotel, transitional shelters, or landlords to cover rent. In some embodiments, the policy may also cover a minimum amount for an electronic device and monthly service, sufficient to utilize the present approach. In addition, case managers assist the insured to overcome homelessness after-which the claims manager assigned to the insured helps them to transition to Homeless Prevention Insurance. Advantageously, claims are made through the electronic device, which may use a website or application. Then a case and claims manager are assigned. They both receive the claim online at the same time. The claims manager works on the insured policy and claim while the case manager begins the process of locating homeless resources in the area closest to the address used on the insureds file. The application updates the claim/case management information so that the insured sees the notes and messages/updates in near-real time. Advantageously, the system also tracks and retains data relating to the insured's policy and actions towards securing employment and improving financial status, as well as claims and related pay-outs. This data may be used in providing the most valuable services to an individual insured, from substance abuse counseling, to job skills, to effective financial management.

Advantageously, the present approach allows prospective employers to connect with insured who are actively seeking employment. In some embodiments, for example, the application may also allow an insured to receive “help wanted” notices or job postings, designed to connect the insured with potential employment. These opportunities may be specifically designed for individuals having specific skill sets identified through the Homeless Risk Assessment, and even individuals with limited skill sets, but the willingness and availability to work and learn certain skills on the job. In some embodiments, the employer may compensate the insured through the system, allowing the case manager to assist the insured with learning effective financial management skills, as well as reduce the likelihood of relapse (e.g., in instances where substance abuse may have been involved).

In some embodiments, successfully acquiring a housing solution may give the insured an opportunity to upgrade the Homeless Insurance policy to a Homeless Prevention Insurance policy. In other embodiments, the upgrade to a Homeless Prevention Insurance policy may automatically vest upon successfully acquiring a housing solution. In many embodiments the upgrade from a term insurance to a hybrid whole insurance serves as a significant motivator for the insured to take the necessary steps to overcome homelessness, whether it be satisfying debt, increasing income, learning financial skills or other skills, etc. This upgrade is also significant because, to the inventor's knowledge, there is no form of homeless insurance that upgrades from a term product to a whole life product.

It should be appreciated that embodiments of Homeless Insurance are temporary or “term” insurance product. However, unlike any contemporary insurance products, Homeless Insurance includes no barriers to receiving a policy; there is no insurable pool. When completing a Homeless Risk Assessment, candidates identifying as currently homeless are qualified for a Homeless Insurance policy, as described herein.

In some embodiments, the Homeless Insurance may cover individuals experiencing distress due to awaiting medical or veteran's disability. These factors may be identified when completing a Homeless Risk Assessment.

In some embodiments. Homeless Insurance is offered on a term basis, such as a 6-month term, 12-month term, or a two-year term. During the term, the insured is provided with counseling and education in order to overcome homelessness and reduce the risk of becoming homeless. As discussed above, the policy may also provide the insured with various essentials, such as temporary housing, storage, meals, and even job opportunities. Embodiments of the present approach may monitor an insured's usage of these benefits, to track the insured's progress towards overcoming homelessness and financial security. Alternatively, the present approach may also monitor an insured's usage for abuse of benefits, which may trigger a mandatory case manager meeting and improvement plan.

In some embodiments, a Homeless Insurance product may upgrade to Homeless Prevention Insurance, as described elsewhere herein. For example, in some embodiments the insured receives through an electronic a new Homeless Risk Assessment on a pre-determined time basis, such as 1 month, 6 months, 9 months, 12 months, or 2-years, into an active Homeless Insurance policy. The updating Homeless Risk Assessment may also be triggered through the system on certain events, such as successfully securing long-term housing, successfully maintaining employment for a pre-determined time, and the like. When the insured's score on an updating Homeless Risk Assessment hits or drops below a predetermined threshold, such as point 401 shown in FIG. 4, then the insured may receive an option to upgrade. It should be appreciated that the threshold may vary depending on the embodiment, as well as the particular insured's history. For example, in some instances, an insured may not receive an option to upgrade until having retained a certain score for a particular amount of time, demonstrating consistent financial security.

In some embodiments, the present approach takes the form of Homeless Prevention Insurance. The Homeless Prevention insurance acts as a hybrid whole insurance policy that can earn cash value. The cash value in the hybrid policy, which may be similar to a permanent life insurance policy, may be accumulated in multiple ways. For example, the insured can add funds (through a system website or application. In some embodiments, funds may be applied via the premium which pays a portion toward the guaranteed funds part of the policy and a portion toward the cash value.

The policy is generational so it does not end at the insured's death. Instead, the policy is passed down to its beneficiaries. Thus, embodiments of the present approach can continue to earn cash value, but beneficiaries cannot sell it or dissolve it against the original policy holder's request. This allows the insured to assist beneficiaries in avoiding homelessness in the future.

In some embodiments, Homeless Prevention Insurance includes a built-in variable insurance premium. The insurance premium may be adjusted based on an updated Homeless Risk Assessments, taken annually. The insured may be required to complete the same or an updated Homeless Risk Assessment. Depending on changes in the insured's responses, the policy premium may increase or decrease. For example, premium decreases may result if the insured's employment situation shows a steady increase in income, or the insured's debt shows a steady decrease. Similar to how a credit score can change monthly, the Homeless Prevention Insurance policy premium can change based on financial habits that impact the insureds risk level, and reward behavior that decreases the insured's risk.

The Homeless Prevention Insurance policy is designed to be non-descriptive and indiscriminate to people regardless of being rich, middle class or poor. For example, the policy changes at different stages of financial growth. People who are on the poverty line can have a better Homeless Risk Assessment® score than people who are wealthy. As a result, they could have a smaller premium, or they could end up with a larger premium that affords them more cash value.

The Homeless Prevention Insurance, similar to a permanent life insurance policy, may have a cash value that, as described above, changes based on the level of risk of homelessness, as determined through a Homeless Risk Assessment. An insured updates or renews a policy on a rolling basis, such as annually, every 2 years, every 3 years, etc., thereby re-assessing or updating the insured's risk of homelessness. As discussed above, the insured may receive an updating Homeless Risk Assessment periodically, or when a certain event triggers an updating policy (e.g., securing a housing solution, remaining employed for a certain length of time, reducing debt by a certain amount, etc.). Based on the updated score, the premium may change to reflect the updated risk, as shown in FIG. 4. For example, if an insured loses a job, the financial situation changes. The next updating Homeless Risk Assessment would receive different input regarding employment, resulting in a change to the insured's score. In some embodiments, employment may be monitored through the system. For example, as discussed above, in some instances employers may connect with potential employees through the system, and may similarly indicate in the system when employment terminates. As another example, an insured's income-to-debt may change through successfully eliminating or reducing debt (or increasing debt), which may be reflected in responses to a Homeless Risk Assessment.

In some embodiments, the Homeless Prevention Insurance policy is designed to trigger Federal requirements for anyone who purchases a home or owns a business to have Homeless Prevention Insurance. In these embodiments, the insured will take the Homeless Risk Assessment, and receive a premium that is dependent upon the individual's risk of experiencing homelessness.

The Homeless Prevention Policy covers emergencies that will prevent someone from becoming homeless such as a medical or mental disability, sudden accident or pre-existing condition that has gotten worse. The policy may activate to help the insured and will stop paying out based on when the disability kicks in. Claims may be filed entirely online, such as through an application running on an electronic device. The assistance provided is requested in the claim application, reviewed by claim assessors and determined based on proof of need and time of need. In some embodiments, a claim benefit may cover a certain window, such as no more than three months of expenses, and may be based on whether the claimant will be able to improve their situation within that time. The system may also monitor the insured's efforts to improve the situation and, benefits may adjust to encourage the insured's efforts, and also reward certain milestones. In some embodiments, exceptions may be provided to people with medical conditions who are unable to work and are seeking government assistance via disability income.

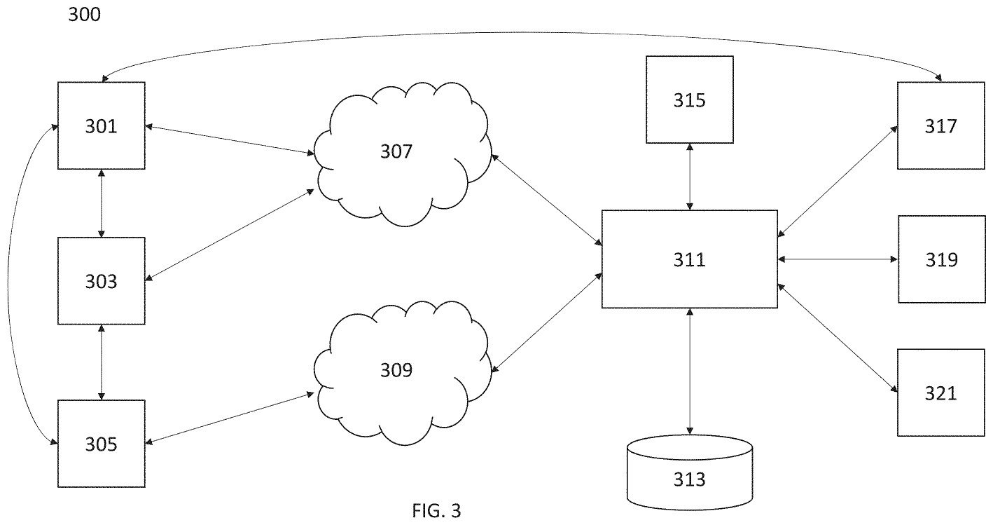

FIG. 3 illustrates an integrated homeless insurance communication system 300 according to an embodiment of the present approach. System 300 may be configured to provide all or portions of the insurance policies and related services described herein. The insured may connect to system 300 using the insured's decide 301, for applying for insurance, completing a questionnaire, providing supporting documents and information, communicating with the insurance provider and other services available through system 300. For example, the insured device 301 is in communication with a local network 307, family/friend/caretaker device 303, shelter/foodbank/other assistance device 305, and government services device 317. The insured device 301 may receive communications through local network 307 from the insurance server 311, such as Homeless Risk Assessment questionnaires, policy information, claim information, instructions for submitting evidence to support a claim, information relating to available services or educational opportunities, and the like. The insured may receive and respond to Homeless Risk Assessment questionnaire's received from insurance server 311, which may be sent at predetermined intervals to monitor the insured's status and progress towards goals. Premium invoices may be transmitted and paid through system 300. The insured's family, friend, or caretaker device 303 may also transmit and receive information through the local network 307 to the insurance server, such as claim information, premium payments, requests for assistance, etc. The insured device 301 and the insured's family, friend, or caretaker device 303 may also transmit and receive information to the policy and claims manager 315.

Insurance database 313 may include information relating to the insured, the insured's policy, documents and information submitted in connection with the insured's policy, prior Homeless Risk Questionnaire questions and responses, future Homeless Risk Questionnaire questions and responses, and the like. Policy and claims manager 315 may access insurance database 313 through insurance server 311, for reviewing a policy, claims, documents and information related to a policy or a claim, status of the insured, premium payment status, policy cash value, etc.

In some embodiments, one or more shelters, food banks, and other sources of assistance, may be connected to system 300. For example, shelter, food bank, other assistance device 305 may be connected to the insured's device 301, the insured's family, friend, or caretaker device 303, and a separate assistance services network 309. In this manner, the insurance server 311 may provide instructions, coverage amount, claim information, etc., to the shelter, food bank, other assistance device 305. In this manner, the insured may receive various assistance under the applicable policy, such as temporary housing and supplies, food, educational services, and the like.

As will be appreciated by one of skill in the art, aspects or portions of the present approach may be embodied as a computer-implemented method, system, and at least in part, on a computer readable medium. Accordingly, the present approach may take the form of combination of hardware and software embodiments (including firmware, resident software, micro-code, etc.) or an embodiment combining software and hardware aspects that may all generally be referred to herein as a “circuit,” “module” or “system.” Furthermore, the present approach may take the form of a computer program product on a computer readable medium having computer-usable program code embodied in the medium. The present approach might also take the form of a combination of such a computer program product with one or more devices, such as a modular sensor brick, systems relating to communications, control, an integrate remote control component, etc.

Any suitable non-transient computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the non-transient computer-readable medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a device accessed via a network, such as the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any non-transient medium that can contain, store, communicate, propagate, or transport the program for use by or in connection with the instruction execution system, apparatus, or device.

Computer program code for carrying out operations of the present approach may be written in an object oriented programming language such as Java, C++, etc. However, the computer program code for carrying out operations of the present approach may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present approach is described below with reference to flowchart illustrations and/or block diagrams of methods, apparatus (systems) and computer program products according to embodiments of the approach. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable memory, including a networked or cloud accessible memory, that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to specially configure it to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present approach may be presented and responded to via a graphical user interface (GUI) presented on the display of the mobile communications device or the like. Prompts may also be audible, vibrating, etc. Any flowcharts and block diagrams in the Figures illustrate the architecture, functionality, and operation of possible implementations of systems, methods and computer program products according to various embodiments of the present approach. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for describing particular embodiments only and is not intended to be limiting of the approach. As used herein, the singular forms “a.” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed is:

1. A computer-implement system for providing and managing homeless insurance policies, the system comprising:
an insurance server having an insurance database, the insurance database including an electronic homeless risk assessment questionnaire, a candidate risk assessment database, an insured risk assessment database, a homeless risk score database, a processor, and a non-transitory memory;
a plurality of user electronic devices in communication with an insurance server, wherein the user electronic devices include candidate electronic devices and insured electronic devices;
a policy and claims manager electronic device in communication with an insurance server;
wherein the non-transitory memory stores instructions that, when executed by the processor, cause the insurance server to:
receive homeless insurance requests from candidate electronic devices, and
distribute electronic risk assessments to the candidate electronic devices in response to the homeless insurance requests;
receive electronic risk assessments from candidate electronic devices, calculate a homeless risk score for each candidate based on electronic risk assessment responses, and update the homeless risk score database with the calculated homeless risk scores;
from the received electronic risk assessments from candidate electronic devices, identify a first portion of candidates currently homeless, and transmit a homeless insurance policy offer to the first portion of candidate electronic devices;
from the received electronic risk assessments from candidate electronic devices, identify a second portion of candidates having a risk of homelessness, and transmit a homeless protection insurance policy offer to the second portion of candidate electronic devices, wherein the homeless protection insurance policy offer includes a premium amount for each candidate inversely related to the candidate's risk of homelessness;
identify a portion of insured electronic devices due for receipt of an electronic homeless risk assessment, and deliver electronic homeless risk assessments to the identified portion of insured electronic devices;
receive electronic risk assessments from insured electronic devices, calculate an updated homeless risk score for each insured based on electronic risk assessment responses, and update the homeless risk score database with the updated homeless risk scores;
from the updated homeless risk scores, identify a rust portion of insured qualified for a change in premium, update the insurance database with the change in premium, and transmit to the first portion of insured electronic devices the change in premium;
from the updated homeless risk scores, identify a second portion of insured qualified for a change in cash value accrual, update the insurance database with the change in cash value accrual, and transmit to the second portion of insured electronic devices the change in cash value accrual; and
receive claims and claim information from insured electronic devices, updating the insurance database with the claim and claim information, transmit a claim summary to the policy and claims manager electronic device, identify service benefits associated with each claim, and transmit the identified service benefits associated with a particular claim to the claiming insured electronic device.

2. The system of claim 1, further comprising a plurality of service benefit electronic devices, and wherein the non-transitory memory stores instructions that, when executed by the processor, cause the insurance server to transmit the claim summary and an identified service benefit associated with a claim to a service benefit electronic device, thereby providing the identified service benefit to the insured.

3. The system of claim 2, wherein the non-transitory memory stores instructions that, when executed by the processor, cause the insurance server to:
receive service reports from the plurality of service benefit electronic devices, a service report containing a claim identifier, insured identifier, identified service benefit, and a confirmation of services provided;
update the insurance database with the service report and an expected electronic homeless risk assessment questionnaire change;
send a claim update summary to the policy and claims manager electronic device with an option for the policy and claims manager electronic device to instruct the insurance server to transmit an updating electronic homeless risk assessment to a specified insured electronic device;
if instructed, transmit an updating electronic homeless risk assessment to a specified insured electronic device;
receive an updated electronic homeless risk assessment to a specified insured electronic device;
compare the updated electronic homeless risk assessment to the expected electronic homeless risk assessment questionnaire change; and
send a second claim update summary to the policy and claims manager electronic database comparing the updated electronic homeless risk assessment to the expected electronic homeless risk assessment questionnaire change.

4. The system of claim 1, further comprising a cash value database, and wherein the non-transitory memory stores instructions that, when executed by the processor, cause the insurance server to update the cash value of a homeless protection insurance policy upon receipt of a premium payment, and in view of a cash value accrual.

5. The system of claim 4, wherein the insurance server further comprises beneficiary designations data, and wherein the non-transitory memory stores instructions that, when executed by the processor, cause the insurance server to transmit a request for beneficiary designations data to an insured electronic device, and receive beneficiary designations data from an insured electronic device, and update the beneficiary designations data.

6. The system of claim 1, further comprising a plurality of prospective employer electronic devices, and wherein the non-transitory memory stores instructions that, when executed by the processor, cause the insurance server to receive prospective employment data from a prospective employer electronic device, and transmit prospective employment opportunity data to a portion of the insured electronic devices.

7. The system of claim 1, further comprising an insured status database having housing and employment information for a portion of insured, and wherein the non-transitory memory stores instructions that, when executed by the processor, cause the insurance server to transmit to the portion of insured a status update request, receive a status update from an insured electronic device updating at least one of housing status and employment status, and then update the insured status database with updated housing and employment information.

8. The system of claim 7, wherein the non-transitory memory stores instructions that, when executed by the processor, cause the insurance server to, upon receipt of a status update from an insured electronic device, send an update summary to the policy and claims manager electronic device with an option for the policy and claims manager electronic device to instruct the insurance server to transmit an updating electronic homeless risk assessment to a specified insured electronic device.

9. The system of claim 7, further comprising a payment database comprising data indicating wages earned by a specified insured, and wherein the payment database is configured to receive wages paid to a specified insured by a specified employer, and the non-transitory memory stores instructions that, when executed by the processor, cause the insurance server to transmit a wage notification to the specific insured electronic device.

10. The system of claim 1, wherein a service benefit comprises one of a storage facility payment, a housing payment, a meal payment, an electronic device payment, and an education seminar.

11. The system of claim 1, wherein the non-transitory memory stores instructions that, when executed by the processor, cause the insurance server to receive an updated electronic risk assessments from an insured electronic device, calculate an updated homeless risk score for the specific insured associated with the insured electronic device, and based on the updated homeless risk score, transmit an offer to the specific insured electronic device to upgrade a homeless insurance policy to a homeless prevention insurance policy, the offer containing an estimated premium based on the updated homeless risk score.

12. The system of claim 11, wherein the non-transitory memory stores instructions that, when executed by the processor, cause the insurance server to receive an acceptance from the specific insured electronic device, and update the insurance database with the specific insured's acceptance, a new homeless prevention insurance policy identifier, and a premium associated with the new homeless prevention insurance policy identifier.

13. The system of claim 1, wherein the electronic homeless risk assessment questionnaire comprises pre-generated questions and answer selections relating to an individual's age, address, credit rating, state of employment, employment history, salary, net worth, debt load, student loan debt, education level, military service, housing history, and homelessness history.
